(19) United States
(12) Patent Application Publication
(10) Pub. No.: US 2013/0156437 A1
(43) Pub. Date: Jun. 20, 2013

(54) TERAHERTZ TRANSMITTER

(71) Applicants: Sungil KIM, Daejeon (KR); Taeyong KIM, Daejeon (KR); Min Hwan KWAK, Daejeon (KR); Seungbeom KANG, Chungcheongbuck-do (KR); Kwang-Yong KANG, Daejeon (KR)

(72) Inventors: Sungil KIM, Daejeon (KR); Taeyong KIM, Daejeon (KR); Min Hwan KWAK, Daejeon (KR); Seungbeom KANG, Chungcheongbuck-do (KR); Kwang-Yong KANG, Daejeon (KR)

(73) Assignee: ELECTRONICS AND TELECOMMUNICATIONS RESEARCH INSTITUTE, Daejeon (KR)

(21) Appl. No.: 13/618,681

(22) Filed: Sep. 14, 2012

(30) Foreign Application Priority Data
Dec. 16, 2011 (KR) 10-2011-0136591

(51) Int. Cl. H04B 10/04

(52) U.S. Cl. 398/115

(57) ABSTRACT

Disclosed is a terahertz transmitter which includes a photonics oscillator configured to generate two optical signals with different wavelength and strong correlation; a modulator configured to modulate the optical signals; a pre-amplifier configured to amplify the modulated optical signals; a photomixer configured to generate a terahertz signal through photomixing of the amplified optical signals; and a post-amplifier configured to amplify the terahertz signal and to transmit the amplified terahertz signal through an antenna.

### CROSS-REFERENCE TO RELATED APPLICATIONS

A claim for priority under 35 U.S.C. §119 is made to Korean Patent Application No. 10-2011-0136591 filed Dec. 16, 2011, in the Korean Intellectual Property Office, the entire contents of which are hereby incorporated by reference.

### BACKGROUND

The inventive concepts described herein relate to a wireless transmission system, and more particularly, relate to a terahertz wave transmitter sending a signal of a terahertz band.

A wireless transmission system using a signal of a terahertz band may include a terahertz wave transmitter sending a signal of a terahertz band and a terahertz wave receiver receiving a signal of a terahertz band. The terahertz band may be a frequency band which has a strong straightness and in which an electromagnetic wave is seriously attenuated due to moisture in the air. Fine alignment between a terahertz wave transmitter and a terahertz wave receiver may be required to transmit a signal using a frequency signal of a terahertz band. Signal loss may be generated according to an alignment error with a terahertz wave receiver.

### SUMMARY

Example embodiments of the inventive concept provide a terahertz transmitter comprising a photonics oscillator configured to generate two optical signals with different wavelengths and strong correlations; a modulator configured to modulate the optical signals; a pre-amplifier configured to amplify the modulated optical signals; a photomixer configured to generate a terahertz signal through photomixing of the amplified optical signals; and a post-amplifier configured to amplify the terahertz signal and to transmit the amplified terahertz signal through an antenna.

In example embodiments, the photonics oscillator generates two optical signals having the same wavelength difference as a frequency of a terahertz signal.

Example embodiments of the inventive concept also provide a terahertz transmitter comprising a photonics oscillator configured to generate two optical signals with wavelength and strong correlations; a modulator configured to modulate the optical signals; an optical splitter configured to split the modulated optical signals; a plurality of photomixers configured to generate a terahertz signal through photomixing of the split optical signals; and a post-amplifier configured to amplify the terahertz signal and to transmit the amplified terahertz signal through an antenna.

In example embodiments, the photonics oscillator generates two optical signals having the same wavelength difference as a frequency of a terahertz signal.

In example embodiments, the terahertz transmitter further comprises a pre-amplifier placed between the modulator and the optical splitter and configured to amplify the modulated optical signals and to output the amplified optical signals to the optical splitter.

In example embodiments, the terahertz transmitter further comprises a plurality of pre-amplifiers placed between the modulator and the plurality of photomixers and configured to amplify the split optical signals and to output the amplified optical signals to the photomixers.

In example embodiments, the optical splitter and the plurality of photomixers are connected through optical fibers, respectively.

In example embodiments, the plurality of photomixers generates a terahertz signal by mixing optical signals through beating of amplified optical signals.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a terahertz transmitter according to an embodiment of the inventive concept.

FIG. 2 is a block diagram schematically illustrating a terahertz transmitter according to another embodiment of the inventive concept.

FIG. 3 is a block diagram schematically illustrating a terahertz transmitter according to still another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass strong orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

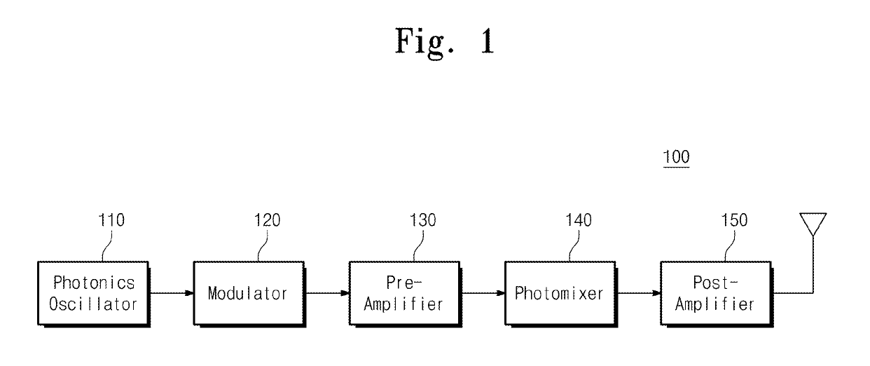

FIG. 1 is a block diagram schematically illustrating a terahertz transmitter according to an embodiment of the inventive concept.

Referring to FIG. 1, a terahertz transmitter 100 may include a photonics oscillator 110, a modulator 120, a pre-amplifier 130, a photomixer 140, and a post-amplifier 150.

The photonics oscillator 110 may generate two optical signals having the same wavelength different as a frequency of a terahertz signal. The photonics oscillator 110 may generate two optical signals the correlation of which is different (or, strong (large)). The photonics oscillator 110 may output the optical signals to the modulator 120.

The modulator 120 may modulate the optical signals based on transmission data. The modulator 120 may output the modulated optical signals to the pre-amplifier 130.

The pre-amplifier 130 may amplify the modulated optical signals. Herein, the pre-amplifier 130 may be an optical amplifier for amplifying an optical signal. The pre-amplifier 130 may compensate for decrease in a signal magnitude or signal strength by amplifying an optical signal. The pre-amplifier 130 may output the amplified optical signal to the photomixer 140.

The photomixer 140 may perform photomixing through beating of the amplified optical signals. Herein, the optical signals may be signals having different wavelengths, and the correlation between the different wavelengths may be strong. The photomixer 140 may output a terahertz signal through the photomixing. Herein, a terahertz signal may be a signal corresponding to a terahertz band. The photomixer 140 may output the terahertz signal to the post-amplifier 150.

The post-amplifier 150 may amplify the terahertz signal. The post-amplifier 150 may be an electron device based amplifier for amplifying a terahertz signal. The post-amplifier 150 may transmit the amplified terahertz signal through an antenna.

With the inventive concept, a terahertz continuous wave signal with a high signal-to-noise ratio by generating a terahertz signal of a 0.1 THz band using an optical signal. Thus, the terahertz transmitter of the inventive concept may minimize signal loss compared with a conventional terahertz transmitter which generates a terahertz signal by alternatively multiplying and amplifying a reference signal source of a several or several dozen GHz band.

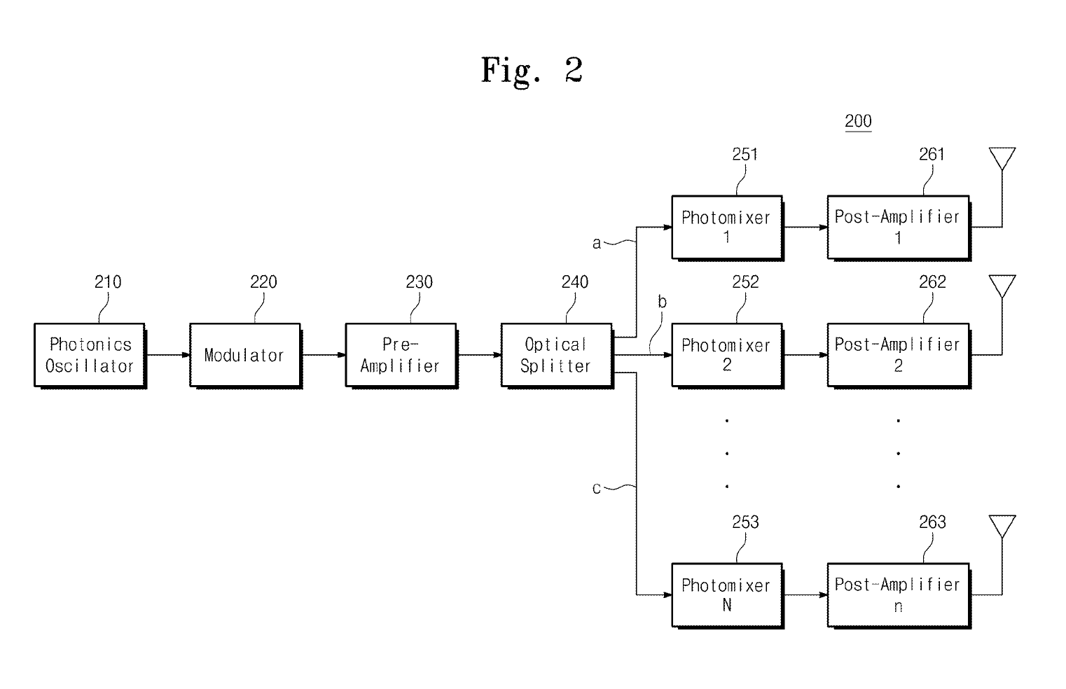

FIG. 2 is a block diagram schematically illustrating a terahertz transmitter according to another embodiment of the inventive concept.

Referring to FIG. 2, a terahertz transmitter 200 may include a photonics oscillator 210, a modulator 220, a pre-amplifier 230, an optical splitter 240, photomixers 251 to 253, and post-amplifiers 261 to 263.

The photonics oscillator 210 may generate two optical signals with the different wavelengths same as a frequency of a terahertz signal. The photonics oscillator 210 may generate two optical signals the correlation of which is strong (or large). The photonics oscillator 210 may output the optical signals to the modulator 220.

The modulator 220 may modulate the optical signals based on transmission data. The modulator 220 may output the modulated optical signals to the pre-amplifier 230.

The pre-amplifier 230 may amplify the modulated optical signals. Herein, the pre-amplifier 230 may be an optical amplifier for amplifying an optical signal. The pre-amplifier 230 may compensate for decrease in a signal magnitude or signal strength by amplifying an optical signal. The pre-amplifier 230 may output the amplified optical signal to the optical splitter 240.

The optical splitter 240 may split the amplified optical signal to correspond to the number of the photomixers 251 to 253. The optical splitter 240 may output the split optical signals to the photomixers 251 to 253, respectively.

The first photomixer 251 may receive the split optical signals. For example, the first photomixer 251 may perform photomixing through beating of the split optical signals. Herein, the optical signals may be signals having two different wavelengths, and the correlation between the wavelengths may be strong. The first photomixer 251 may output a terahertz signal through the photomixing. Herein, a terahertz signal may be a signal corresponding to a terahertz band. The photomixer 251 may output the terahertz signal to a first post-amplifier 261.

The remaining photomixers 252 to 253 may operate substantially the same as described through the first photomixer 251, and description thereof is thus omitted. The photomixer 252 may output a terahertz signal to a second post-amplifier 262, and the photomixer 253 may output a terahertz signal to an nth post-amplifier 263.

The optical splitter 240 and the photomixers 251 to 253 may be connected through optical fibers a, b, and c. Herein, the optical fibers a, b, and c may be formed of a polarization maintaining fiber (PMF) having a low loss factor. The optical splitter 240 may output the split optical signals to the photomixers 251 to 253 through the optical fibers a, b, and c. Thus, it is possible to minimize signal loss due to an alignment error between the terahertz transmitter 200 and a terahertz receiver receiving a terahertz signal.

The post-amplifier 261 may amplify the terahertz signal. The post-amplifier 261 may be an electron device based amplifier for amplifying a terahertz signal. The post-amplifier 261 may transmit the amplified terahertz signal through an antenna.

The remaining post-amplifiers 262 to 263 may operate substantially the same as described through the post-amplifier 261, and description thereof is thus omitted. The post-amplifier 262 may transmit an amplified terahertz signal through an antenna, and the post-amplifier 263 may transmit an amplified terahertz signal through an antenna.

As described above, a terahertz signal may be transmitted using the arrayed photomixers 251 to 253 and post-amplifiers 261 to 263. As a signal is transmitted through signal processing based on an optical signal, it is possible to minimize signal loss due to an alignment error between a terahertz transmitter and a terahertz receiver.

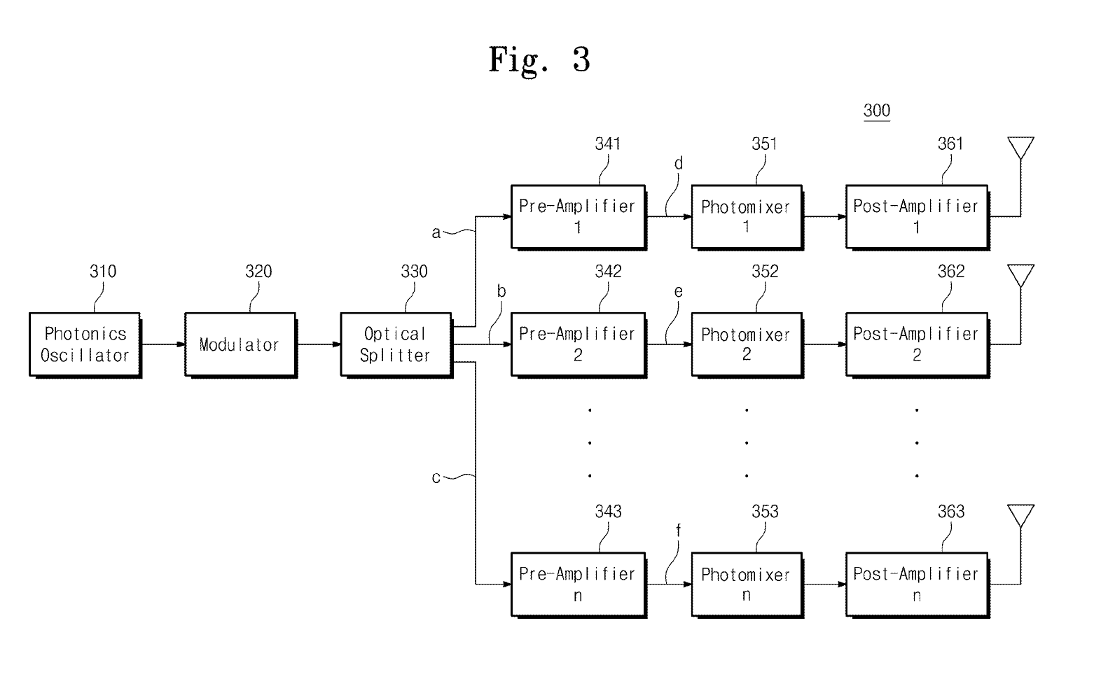

FIG. 3 is a block diagram schematically illustrating a terahertz transmitter according to still another embodiment of the inventive concept.

Referring to FIG. 3, a terahertz transmitter 300 may include a photonics oscillator 310, a modulator 320, an optical splitter 330, pre-amplifiers 341 to 343, photomixers 351 to 353, and post-amplifiers 361 to 363.

A terahertz transmitter 300 in FIG. 3 may be analogous to a terahertz transmitter 200 in FIG. 2. However, while the terahertz transmitter 200 in FIG. 2 amplifies an optical signal prior to an optical splitter 240, the terahertz transmitter 300 in FIG. 3 may amplify an optical signal after optical signals are split by the optical splitter 330.

The photonics oscillator 310 may generate two different optical signals with the different wavelength same as a frequency of a terahertz signal. The photonics oscillator 310 may generate two optical signals the correlation of which is strong (or large). The photonics oscillator 310 may output the optical signals to the modulator 320.

The modulator 320 may modulate the optical signals based on transmission data. The modulator 320 may output the modulated optical signals to the optical splitter 330.

The optical splitter 330 may split the amplified optical signal to correspond to the number of the pre-amplifiers 341 to 343. The optical splitter 330 may output the split optical signals to the pre-amplifiers 341 to 343.

The pre-amplifier 341 may amplify the split optical signals. Herein, the pre-amplifier 341 may be an optical amplifier for amplifying an optical signal.

The pre-amplifier 341 may compensate for decrease in a signal magnitude or signal strength by amplifying an optical signal. The pre-amplifier 341 may output the amplified optical signal to a first photomixer 351.

The remaining pre-amplifiers 342 to 343 may operate substantially the same as described through the pre-amplifier 341, and description thereof is thus omitted. The pre-amplifier 342 may output an amplified optical signal to a photomixer 352, and the pre-amplifier 343 may output an amplified optical signal to a photomixer 353.

Each of the pre-amplifiers 341 to 343 may compensate for signal attenuation due to the optical splitter 330 as well as signal attenuation due to the modulator 320.

The first photomixer 351 may receive the amplified optical signals. For example, the first photomixer 351 may perform photomixing through beating of the amplified optical signals. Herein, the optical signals may be signals having two different wavelengths, and the correlation between the wavelengths may be strong. The first photomixer 351 may output a terahertz signal through the photomixing. Herein, a terahertz signal may be a signal corresponding to a terahertz band. The photomixer 351 may output the terahertz signal to a first post-amplifier 361.

The remaining photomixers 352 to 353 may operate substantially the same as described through the first photomixer 351, and description thereof is thus omitted. The photomixer 352 may output a terahertz signal generated from an amplified optical signal to a second post-amplifier 362, and the photomixer 353 may output a terahertz signal generated from an amplified optical signal to an nth post-amplifier 363.

The optical splitter 330 and the photomixers 351 to 353 may be connected through optical fibers a to f. Herein, the optical fibers a to f may be formed of a polarization maintaining fiber (PMF) having a low loss factor. The optical splitter 330 may output the split optical signals to the pre-amplifiers 341 to 343 through the optical fibers a, b, and c, and the pre-amplifiers 341 to 343 may output the amplified optical signals to the photomixers 351 to 353 through the optical fibers d, e, and f. Thus, it is possible to minimize signal loss due to an alignment error between the terahertz transmitter 300 and a terahertz receiver receiving a terahertz signal.

The post-amplifier 361 may amplify the terahertz signal. The post-amplifier 361 may be an electron device based amplifier for amplifying a terahertz signal. The post-amplifier 361 may transmit the amplified terahertz signal through an antenna.

The remaining post-amplifiers 362 to 363 may operate substantially the same as described through the post-amplifier 361, and description thereof is thus omitted. The post-amplifier 362 may transmit an amplified terahertz signal through an antenna, and the post-amplifier 363 may transmit an amplified terahertz signal through an antenna.

As described above, a terahertz signal may be transmitted using the arrayed pre-amplifiers 341 to 343, photomixers 351 to 353 and post-amplifiers 361 to 363. As a signal is transmitted through signal processing based on an optical signal, it is possible to minimize signal loss due to an alignment error between a terahertz transmitter and a terahertz receiver.

A terahertz receiver corresponding to a terahertz transmitter of the inventive concept may receive a terahertz signal using an envelope detecting manner or a heterodyne manner. Further, the terahertz receiver may include a clock data recovery (CDR) circuit for improvement of reception sensitivity. The terahertz receiver will be described under the condition that signals are transmitted and received using one antenna. In this case, a circulator may be used when signals are transmitted and received at different periods of time, and a duplexer may be used when signals are transmitted and received at the same period of time.

Since a signal transfer is made through a line of sight due to a property of a frequency band such as a terahertz band, alignment of an antenna for transmission and reception may affect the performance of the terahertz receiver. Thus, without using a separate alignment device, the terahertz receiver may include an antenna adjusting device which is configured to measure a magnitude of an input signal through diverging of an input terahertz wave signal and to minimize signal loss caused due to an alignment error of an antenna for transmission and reception compared with a magnitude of a previously input signal.

For example, the terahertz transmitter of the inventive concept (or, a terahertz receiver corresponding to a terahertz transmitter of the inventive concept) may be applied to transmit HD multimedia data and 3D multimedia data. In the event that multimedia data is used for sports broadcasting and remote treatment, a non-compression transfer may be essential for a real-time transfer without a time delay. For example, a data transfer speed of about 3 Gbps may be required to perform a non-compression transfer on an HD image, which maintains a bit error rate (BER) and a resolution of 1920 by 1080 and a frame rate of about 60 Hz, without a time delay. Also, a data transfer speed 1.5 times higher than an HD data transfer speed may be required to transfer an image for 3D TV. A bandwidth of about 2 GHz may be required to transfer a channel of a non-compressed HD image signal.

The terahertz transmitter may be applied to a data transfer using a terahertz signal in a broadcasting communication system in which the amount of data to be transferred increases. However, the inventive concept is not limited thereto.

The terahertz transmitter of the inventive concept may minimize signal loss due to a terahertz signal transfer by generating a terahertz signal having a high signal-to-noise ratio using a photonics oscillator. An alignment error with a signal receiver may be minimized by sending a plurality of terahertz signals using a plurality of optical fibers and an array structure.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A terahertz transmitter comprising:
a photonics oscillator configured to generate two optical signals with different wavelengths and strong correlations;
a modulator configured to modulate the optical signals;
a pre-amplifier configured to amplify the modulated optical signals;
a photomixer configured to generate a terahertz signal through photomixing of the amplified optical signals; and
a post-amplifier configured to amplify the terahertz signal and to transmit the amplified terahertz signal through an antenna.

2. The terahertz transmitter of claim 1, wherein the photonics oscillator generates two optical signals having the same wavelength difference as a frequency of a terahertz signal.

3. A terahertz transmitter comprising:
a photonics oscillator configured to generate two optical signals with wavelength and strong correlations;
a modulator configured to modulate the optical signals;
an optical splitter configured to split the modulated optical signals;
a plurality of photomixers configured to generate a terahertz signal through photomixing of the split optical signals; and
a post-amplifier configured to amplify the terahertz signal and to transmit the amplified terahertz signal through an antenna.

4. The terahertz transmitter of claim 3, wherein the photonics oscillator generates two optical signals having the same wavelength difference as a frequency of a terahertz signal.

5. The terahertz transmitter of claim 3, further comprising:
a pre-amplifier placed between the modulator and the optical splitter and configured to amplify the modulated optical signals and to output the amplified optical signals to the optical splitter.

6. The terahertz transmitter of claim 3, further comprising:
a plurality of pre-amplifiers placed between the modulator and the plurality of photomixers and configured to amplify the split optical signals and to output the amplified optical signals to the photomixers.

7. The terahertz transmitter of claim 3, wherein the optical splitter and the plurality of photomixers are connected through optical fibers, respectively.

8. The terahertz transmitter of claim 3, wherein the plurality of photomixers generates a terahertz signal by mixing optical signals through beating of amplified optical signals.
